(19) United States
(12) Patent Application Publication
(10) Pub. No.: US 2003/0226271 A1
(43) Pub. Date: Dec. 11, 2003

(54) Tile spacer

(76) Inventor: Victor David Cordell, Asheville, NC (US)

Correspondence Address: Victor D. Cordell, 42 Florida Place, Asheville, NC, 28806, US

(21) Appl. No.: 10/455,209

(22) Filed: Jun. 5, 2003

Related U.S. Application Data
(60) Provisional application No. 60/385,970, filed on Jun. 5, 2002.

(51) Int. Cl. G01D 21/00

(52) U.S. Cl. 33/526

(57) ABSTRACT

A long, flat, rigid, rectangular tile spacer (12) used to create a uniform space (18) between tiles (16) as they are being installed.

### CROSS-REFERENCE TO RELATED APPLICATIONS

“This application claims the benefit of PPA Ser. No. 60/385,970 filed: Jun. 5, 2002 12:29 PM

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to the installation of tile.

### BACKGROUND OF THE INVENTION

When ceramic tile is installed it is necessary to create a space between the edges of adjacently set tiles. This space is usually ⅛″ to ½″ wide and is later filled with a substance called grout which hardens and creates a watertight joint between each tile. Thus the whole completed tile surface is advantageous in moist environments. For aesthetic reasons the aforementioned spaces between all adjacent tiles must be kept uniform in width so the rows of installed tile will be parallel.

US patent application 20020121027 to Kruskamp (2000) discloses a tile spacer that suffers from a number of disadvantages:

(a) They are too small for a human hand to dexterously grasp and are often dropped or mispositioned. This wastes time.

(b) These tile spacers are difficult to quickly clean due to their small size and inside corners. Because they are designed to be left between tiles until the adhesive is dry they often have dry adhesive on them. Thus they-are not easily reused and must be continuously replaced.

(c) Because these tile spacers lack sharp outside edges and corners, and sufficient rigidity and size they cannot be used to clean a new space of excess adhesive and foreign object debris.

(d) These spacers take longer to use because they cannot be advanced to the location of the next tile to be laid without lifting them from a previous location.

(e) They cannot be used to tap the top surfaces of adjacent tiles in order to push the adjacent tiles deeper into the applied adhesive in order to level them.

### BACKGROUND OF INVENTION—OBJECTS AND ADVANTAGES

Accordingly several objects and advantages of the present invention are:

(a) to provide a tile spacer with sufficient surface area to enable it to be easily grasped and manipulated by a human hand;

(b) to provide a tile spacer that can be easily cleaned before any adhesive on it drys;

(c) to provide a tile spacer that can clean out a newly created space of unwanted material by scraping the inside of the space with its sharp corners and edges;

(d) to provide a tile spacer that can be quickly slid from one tile joint to the location of the next one without the need to lift it in order to save time;

(e) to provide a tile spacer that can also be used to tap the top surfaces of adjacently set tiles into the same geometric plane thus creating an even tile surface;

(f) to provide a tile spacer that can be reused many times.

### SUMMARY

In accordance with the present invention a tile spacer comprises a rectangular body of predetermined dimensions to create a space between tiles.

### DRAWINGS—FIGURES

FIG. 1 shows a three view mechanical drawing.

FIG. 2 shows a pictorial view of the tile spacer between two tiles.

FIG. 3 shows an end view of the tile spacer between two tiles.

FIG. 4 shows the tile spacer being used to level two adjacent tiles.

### DRAWINGS—REFERENCE NUMERALS

10 widest side of spacer

12 spacer

14 edge of tile or small side of tile

16 tile

18 space

20 thickness of spacer

22 unwanted excess adhesive

24 sharp bottom edge of tile spacer

26 sharp side edge of tile spacer

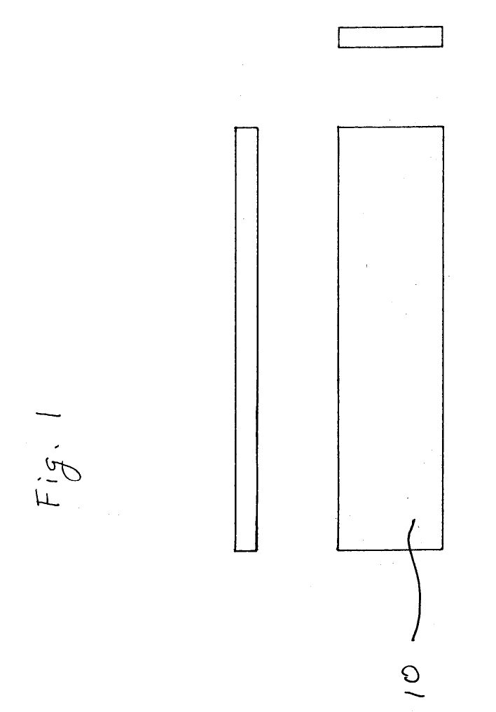

### DETAILED DESCRIPTION—FIG. 1

The tile spacer has two identical, flat, smooth, hard, rigid, parallel surfaces 10 each measuring approximately one inch by four inches. These two surfaces are separated from each other by approximately ¼″ by the composite material in which the whole spacer is fabricated which gives the spacer a total of six sides. All its adjacent edges are at right angles to each other. It is rectangular in shape. It is made of a material that is difficult to compress and it is solid throughout.

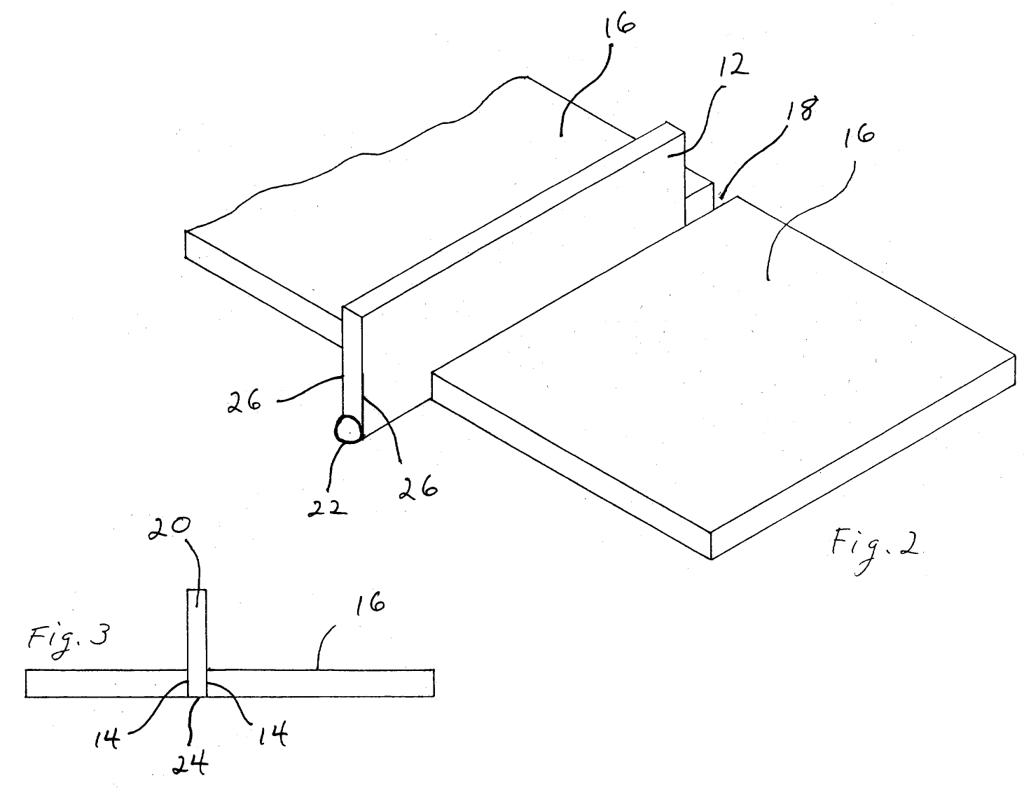

Operation—FIGS. 1, 2, 3, 4

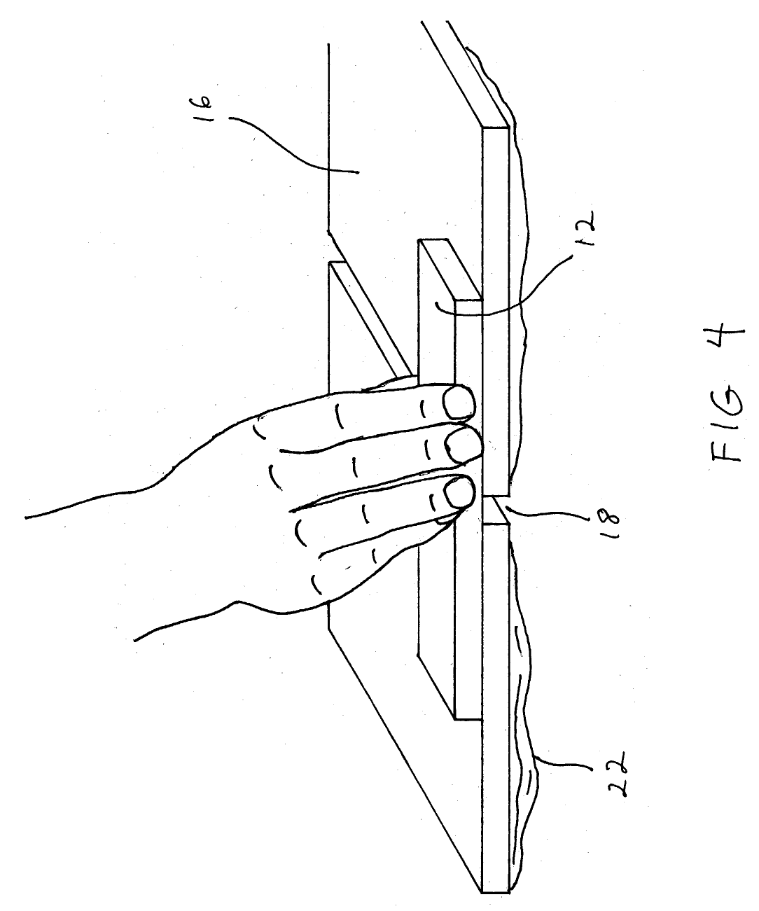

The tile spacer is utilized as a hand tool to create a uniform space between tile as the tile is being installed. This is accomplished by placing the spacer 12 between the edges 14 of two different tiles 16 as they are manually pushed together. The width of the created space 18 is relative to the thickness 20 of the spacer 12. After the tiles 16 are set the spacer 12 is further utilized to remove any excess adhesive 22 that was unintentionally pushed into the space 18 when the tiles 16 were set and any other foreign object debris. This is accomplished by moving the spacer 12 in a back and forth motion prior to its removal from the space 18 thus employing the sharp edges 24, 26 of the spacer 12 to scrape and shovel out the inside of the space 18. After its removal from the space 18 the spacer 12 is further utilized to create an even tile surface. This is accomplished by using the widest side 10 of the spacer 12 to tap FIG. 4 the top surfaces of two adjacently set tiles 16 until their top surfaces are even.

The spacer 12 can be slid without lifting it to the location of the next tile if the user so chooses.

I claim:

1. An apparatus for creating a uniform space between tiles during the installation of the tile, comprising:
(a) two identical, flat, smooth, rigid, hard, parallel, rectangular surfaces
(b) said surfaces being created by and separated from each other a predetermined distance by a composite material that forms the whole into a solid rectangular body whose adjacent edges are at right angles to each other
(c) said rectangular body having one dimension that enables said rectangular body to separate said tiles said distance, said rectangular body having yet another dimension that enables said rectangular body to make continuous direct contact along the entire width of said tile, said rectangular body having yet another dimension that enables said rectangular body to be dexterously manipulated by one human hand while said rectangular body is between two said tiles.

2. A method for removing unwanted material from the space created between tiles, comprising:
(a) providing a tile spacer with a plurality of sharp corners and edges with which to scrape the sides and bottom of said created space in order to remove said unwanted material.

3. A method for causing the top surfaces of adjacent tiles to become even, comprising:
(a) providing a tile spacer with a flat surface area of sufficient dimensions to be used to manually tap said adjacent tiles into the same geometric plane.
